(19) United States
(12) Patent Application Publication
(10) Pub. No.: US 2002/0132515 A1
(43) Pub. Date: Sep. 19, 2002

(54) Electrical plug with circuit-breaking capability

(76) Inventors: Chin-Chuan Hong, Taichung City (TW); Lian-Kuei Lu, Taichung Hsien (TW)

Correspondence Address: Morgan & Finnegan L. L. P., Maria C.H. Lin, 345 Park Avenue, New York, NY, 10154-0053, US

(21) Appl. No.: 09/852,591

(22) Filed: May 10, 2001

(30) Foreign Application Priority Data
Mar. 19, 2001 (TW) 090204099

(51) Int. Cl. H01R 3/00

(52) U.S. Cl. 439/488

(57) ABSTRACT

An electrical plug includes a pair of conductive prongs, each of which is formed as a rectangular plate having opposite lateral edges, and a plug body that is made of an insulator material. The plug body encloses an intermediate portion and one of the end portions of each of the conductive prongs, and exposes the other one of the end portions of the conductive prongs to permit connection of the conductive prongs to an electrical outlet. The intermediate portion of at least one of the conductive prongs is formed with a notch that extends from one of the lateral edges toward the other one of the lateral edges.

### BACKGROUND OF THE INVENTION

1. Field of the Invention

The invention relates to an electrical plug, particularly an electrical plug with a circuit-breaking capability to protect electrical appliances from abnormal current conditions.

2. Description of the Related Art

It is known in the art to use fuse boxes and circuit breakers to protect electrical appliances, such as air-conditioners and refrigerators, from damage due to overload, power outages, and other abnormal current conditions.

### SUMMARY OF THE INVENTION

The object of the present invention is to provide an electrical plug with a circuit-breaking capability to protect electrical appliances from abnormal current conditions.

According to the present invention, an electrical plug comprises a pair of conductive prongs and a plug body. Each of the conductive prongs is formed as a rectangular plate having opposite lateral edges, a first end portion, a second end portion opposite to the first end portion, and an intermediate portion between the first and second end portions. The plug body is made of an insulator material, encloses the intermediate portion and the second end portion of each of the conductive prongs, and exposes the first end portions of the conductive prongs to permit connection of the first end portions of the conductive prongs to an electrical outlet. The intermediate portion of at least one of the conductive prongs is formed with a notch that extends from one of the lateral edges toward the other one of the lateral edges.

In the event of an abnormal current condition, said at least one of the conductive prongs breaks at the intermediate portion thereof, thereby protecting an electrical appliance that is connected to the electrical plug of this invention.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an electrical plug according to the present invention;

FIG. 2 is a schematic view of the first preferred embodiment;

FIG. 3 is perspective view of the second preferred embodiment of an electrical plug according to the present invention;

FIG. 4 is a schematic view of the second preferred embodiment; and

FIG. 5 is a perspective view of a conductive prong of the third preferred embodiment of an electrical plug according to the present invention.

### DETAILED DESCRIPTION OF THE PREFERRED EMBODIMENTS

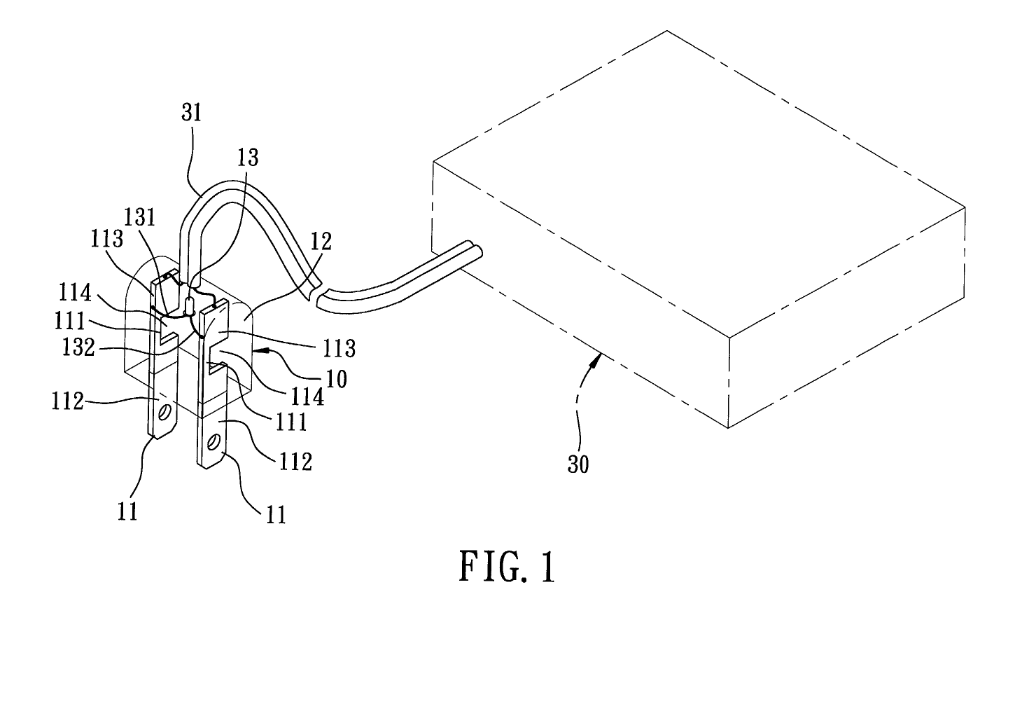

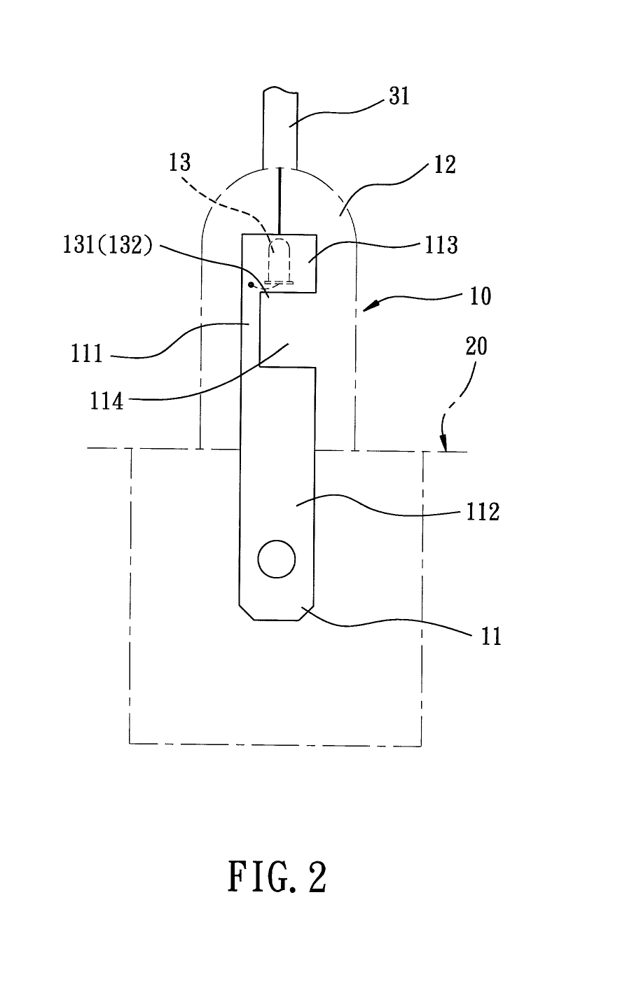

Referring to FIGS. 1 and 2, the first preferred embodiment of an electrical plug 10 according to the present invention is shown to include a pair of conductive prongs 11 and a plug body 12. Each of the conductive prongs 11 is formed as a rectangular plate having opposite lateral edges, a first end portion 112 adapted to be connected to an electrical outlet 20, a second end portion 113 opposite to the first end portion 112 and adapted to be connected to a power supply cable 31 of an electrical appliance 30, and an intermediate portion 111 between the first and second end portions 112, 113 and formed with a notch 114 that extends from one of the lateral edges toward the other one of the lateral edges. The plug body 12 is made of an insulator material, encloses the intermediate portion 111 and the second end portion 113 of each of the conductive prongs 11, and exposes the first end portions 112 of the conductive prongs 11 to permit connection of the first end portions 112 of the conductive prongs 11 to the electrical outlet 20 in a conventional manner.

In use, the electrical plug 10 of the electrical appliance 30 is inserted into the electrical outlet 20. In the event of a power outage, feedback current surges 4 through the conductive prongs 11 of the electrical plug 10, thereby causing the latter to break at the intermediate portions 111 thereof. The circuit is thus broken by the electrical plug 10, and the electrical appliance 30 is protected from damage.

Preferably, the plug body 12 is made of a transparent material. A light emitting member 13, such as a light emitting diode, is enclosed by the plug body 12 and has a pair of terminals 131, 132 connected respectively to the second end portions 113 of the conductive prongs 11 . When the flow of current is normal, the light emitting member 13 emits light that is visible from the exterior of the plug body 12. In case of an overload, the intermediate portions 111 of the conductive prongs 11 break, thereby cutting off the current flow through the light emitting member 13 such that the light from the latter is extinguished. As such, whether or not overloading of the electrical appliance 30 has occurred can be easily detected by monitoring the state of the light emitting member 13 of the electrical plug 10.

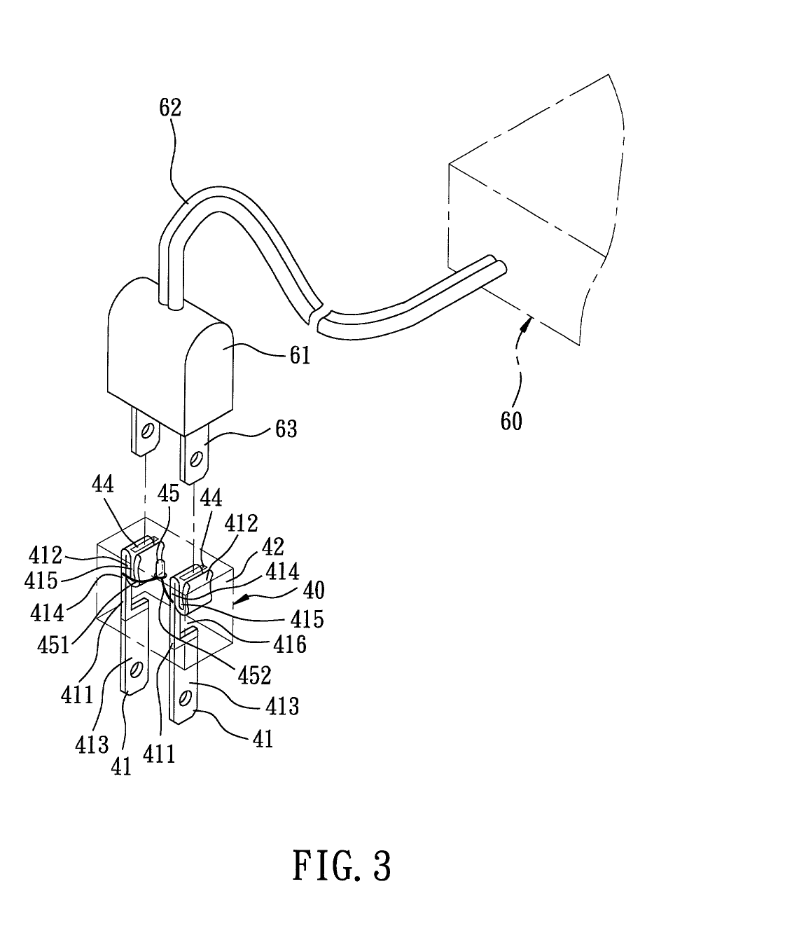

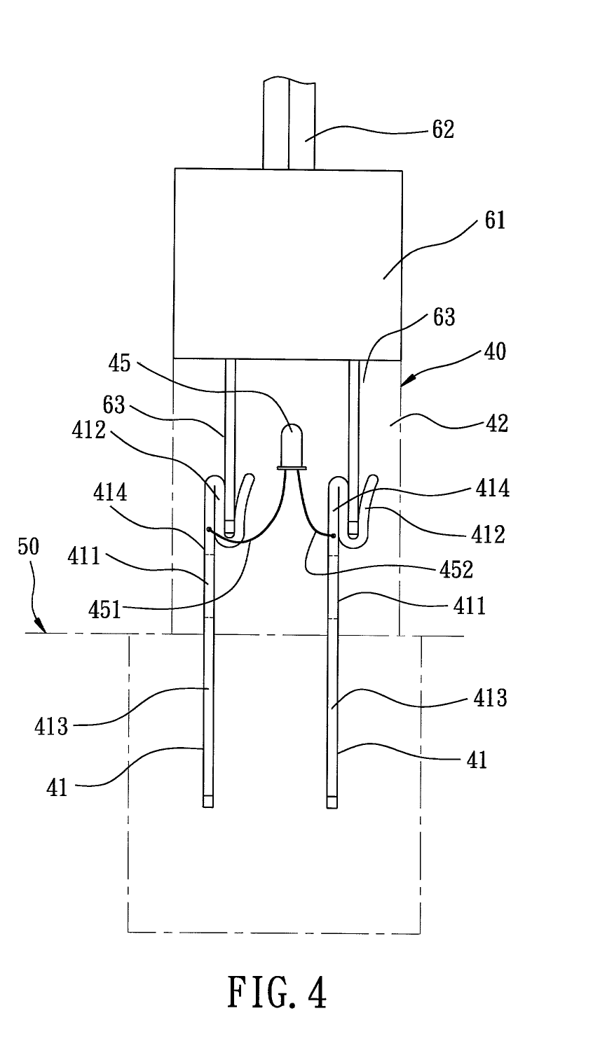

Referring to FIGS. 3 and 4, the second preferred embodiment of an electrical plug 40 according to the present invention is shown to include a pair of conductive prongs 41 and a plug body 42. Each of the conductive prongs 41 is formed as a rectangular plate having opposite lateral edges, a first end portion 413 adapted to be connected to an electrical outlet 50, a second end portion 414 opposite to the first end portion 413 and formed with a prong engaging groove 415, and an intermediate portion 411 between the first and second end portions 413, 414 and formed with a notch 416 that extends from one of the lateral edges toward the other one of the lateral edges. The second end portion 414 of each of the conductive prongs 41 is formed with a U-shaped clamp 412 that opens upwardly and that confines the prong engaging groove 415. The plug body 42 is made of an insulator material, encloses the intermediate portion 411 and the second end portion 414 of each of the conductive prongs 41, and exposes the first end portions 413 of the conductive prongs 41 to permit connection of the first end portions 413 of the conductive prongs 41 to the electrical outlet 50. In this embodiment, the plug body 42 is formed with a pair of prong holes 44 that are registered with the prong engaging grooves 415 of the conductive prongs 41. As such, a pair of prong units 63 of a plug 61 that is connected to a power supply cable 62 of an electrical appliance 60 can be inserted into the prong holes 44 and extend into the prong engaging grooves 415 for coupling electrically the prong units 63 and the conductive prongs 41.

In use, the prong units 63 of the plug 61 of the electrical appliance 60 are inserted into the prong holes 44 so as to extend into the prong engaging grooves 415 at the second end portions 414 of the conductive prongs 41 of the electrical plug 40. In the event of a power outage, feedback current surges through the conductive prongs 41 of the electrical plug 40, thereby causing the latter to break at the intermediate portions 411 thereof. The circuit is thus broken by the electrical plug 40, and the electrical appliance 60 is protected from damage. The broken electrical plug 40 is simply replaced by a new electrical plug 40 to resume supply of electric power to the electrical appliance 60.

Like the previous embodiment, the plug body 42 is made of a transparent material. A light emitting member 45, such as a light emitting diode, is enclosed by the plug body 42 and has a pair of terminals 451, 452 connected respectively to the second end portions 414 of the conductive prongs 41. When the flow of current is normal, the light emitting member 45 emits light that is visible from the exterior of the plug body 42. In case of an overload, the intermediate portions 111 of the conductive prongs 11 break, thereby cutting off the current flow through the light emitting member 45 such that the light from the latter is extinguished. As such, whether or not overloading of the electrical appliance 60 has occurred can be easily detected by monitoring the state of the light emitting member 45 of the electrical plug 40.

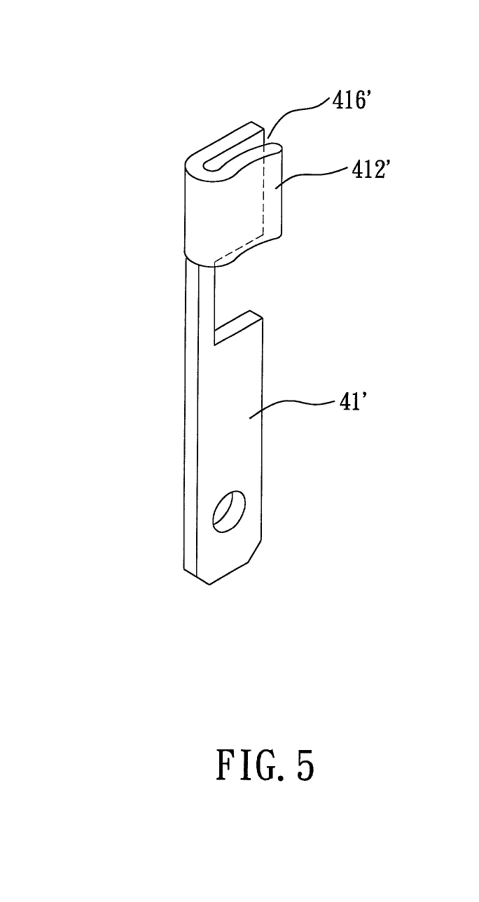

FIG. 5 illustrates a conductive prong 41′ of the third preferred embodiment of an electrical plug according to the present invention. Unlike the conductive prongs 41 of the second preferred embodiment, the second end portion 414 of each of the conductive prongs 41′ is formed with a U-shaped clamp 412′ that opens toward one of the lateral edges and that confines the prong engaging groove 416′. While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An electrical plug comprising:
a pair of conductive prongs, each of which is formed as a rectangular plate having opposite lateral edges, a first end portion, a second end portion opposite to said first end portion, and an intermediate portion between said first and second end portions; and
a plug body made of an insulator material, said plug body enclosing said intermediate portion and said second end portion of each of said conductive prongs, and exposing said first end portions of said conductive prongs to permit connection of said first end portions of said conductive prongs to an electrical outlet;
wherein said intermediate portion of at least one of said conductive prongs is formed with a notch that extends from one of said lateral edges toward the other one of said lateral edges.

2. The electrical plug of claim 1, wherein said second end portions of said conductive prongs are adapted to be connected to a power supply cable of an electrical appliance.

3. The electrical plug of claim 1, wherein said plug body is made of a transparent material, said electrical plug further comprising a light emitting member that is enclosed by said plug body and that has a pair of terminals connected respectively to said second end portions of said conductive prongs.

4. The electrical plug of claim 1, wherein said second end portion of each of said conductive prongs is formed with a prong engaging groove, said plug body being formed with a pair of prong holes that are registered with said prong engaging grooves of said conductive prongs, whereby a pair of prong units of a plug of an electrical appliance can be inserted into said prongs holes and extend into said prong engaging grooves for coupling electrically the prong units and said conductive prongs.

5. The electrical plug of claim 4, wherein said second end portion of each of said conductive prongs is formed with a U-shaped clamp that opens upwardly and that confines said prong engaging groove.

6. The electrical plug of claim 4, wherein said second end portion of each of said conductive prongs is formed with a U-shaped clamp that opens toward one of said lateral edges and that confines said prong engaging groove.
